(19) United States
(12) Patent Application Publication
(10) Pub. No.: US 2006/0242212 A1
(43) Pub. Date: Oct. 26, 2006

(54) Method and arrangement for randomly storing data

(76) Inventors: Andre Brinkmann, Schloss Holte (DE); Christian Scheideler, Paderborn (DE); Friedhelm Meyer auf der Heide, Delbruck (DE); Ulrich Ruckert, Soest (DE); Kay Salzwedel, Paderborn (DE)

Correspondence Address: Richard C Weinblatt;Wolf Block Schorr and Solis-cohen, 1650 Arch Street, 22nd Floor, Philadelphia, PA, 19103, US

(21) Appl. No.: 10/524,159

(22) PCT Filed: May 8, 2003
(86) PCT No.: PCT/EP03/08635

§ 371 Date: Feb. 8, 2005

(30) Foreign Application Priority Data
Aug. 8, 2002 (DE) 102 36 796.5

(51) Int. Cl. G06F 17/30

(52) U.S. Cl. 707/205

(57) ABSTRACT

The invention relates to a method and an arrangement for randomly storing data in storage networks and/or an intranet and/or the Internet, a corresponding computer program product, and a corresponding computer-readable storage medium, which are particularly suitable for distributing and retrieving data in error-tolerant and faulty systems such as storage networks or the Internet. According to the inventive method for randomly storing data in storage networks and/or an intranet and/or the Internet, one or multiple intervals, the total length of which corresponds to the relative capacity of the system, is/are assigned to each storage system. Said intervals are represented in a [0,1) interval but can overlap with other intervals as opposed to existing strategies. A real point is then assigned to each data block within the [0,1) interval by means of a (pseudo)random function. Optionally, said point can be part of several intervals of storage systems. A uniform placement strategy is used in order to assign the data block to one of said storage systems if that is the case. The interval lengths are adjusted correspondingly if the relative capacities of the storage systems change.

The invention at hand regards a method and an arrangement for randomly storing data on storage networks and/or an intranet and/or the Internet as well as a suitable computer program product and a suitable computer readable storage medium that are particularly useful for the distribution and the retrieval of data in error-tolerant and faulty systems, as for example storage networks, an intranet or the Internet.

The organization of multiple data storage systems as an efficient and flexible storage system requires resoluting many problems. One of the most important is finding suitable placement of data, i.e. a suitable distribution of data blocks over the storage system that allows for a quick access to the data and a high degree of security against loss of data. As part of the description below, a distinction is made between a number of units that have access to the data blocks, the clients, and a number of units that deliver the data blocks, the servers. At the same time, the terms server and data storage system are used synonymously.

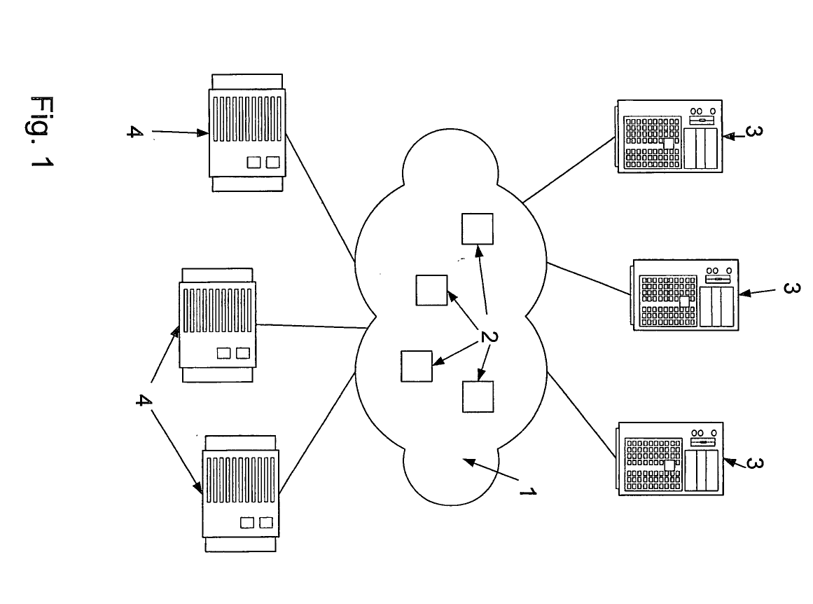

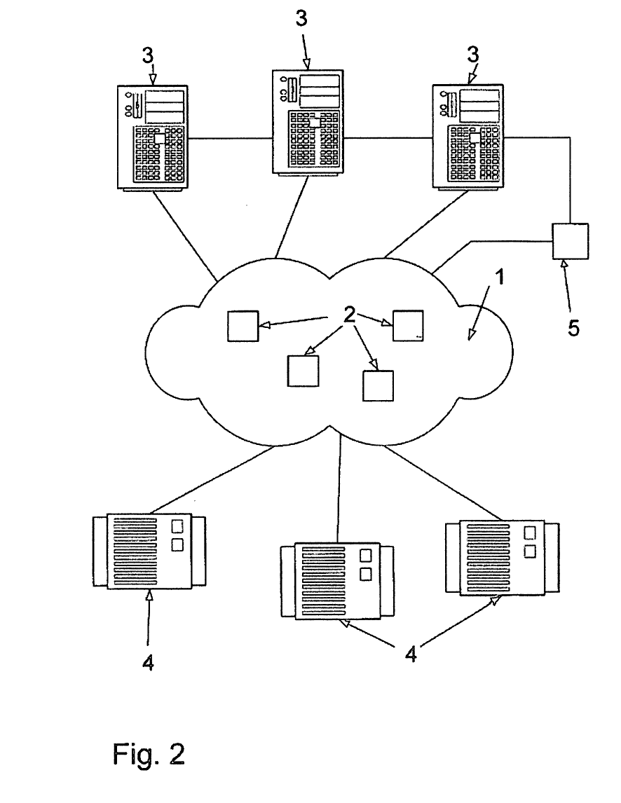

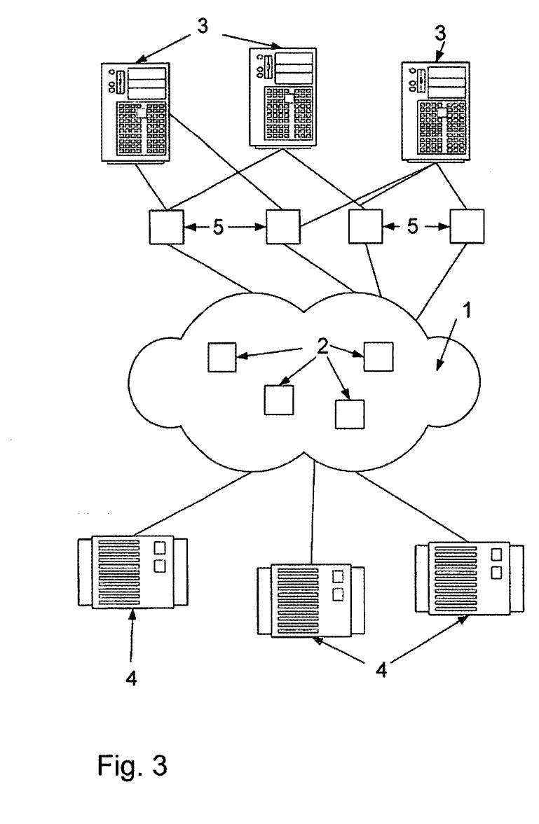

The methods and systems regarded below serve to set up the distributed data servers and storage networks, as well as to set up the web systems for caching data. A distributed data server, or a storage network, in general consists of a number of computer systems which are linked via a network with a number of data storage systems. The linking network between the computer systems and the data storage systems consists of a number of switches or routers that assure the delivery of the data packets between communicating units (see FIG. 1). Furthermore, the system can have a number of SAN appliances (SAN=Storage Area Network) available that can be hooked onto the network and assure coordination between the individual computer systems and the data storage systems (see FIG. 2). Furthermore, so-called in-band appliances can be connected between computer systems and the data storage systems (see FIG. 3). In-band appliances come into use with the so-called in-band virtualization. With in-bank virtualization the controlling level, the in-band appliance, is located in the data stream between server and storage device.

The control data as well as the utilization data also flow through the appliance that appears to the servers as the storage system itself. The allocation of storage segments, also termed logical volumes, to each individual server occurs here. The control of data access also takes place through this appliance. On the other hand, there is also the start of implementing virtualization through the so-called out of band virtualization. In this case, the appliance is located outside of the data path and communicates through the network (for example, a LAN) with the host bus adapter (HBA) on the server that needs a special agent. The appliance defines the logical volumes that a server may use. The server subsequently stores the exact information on the pertinent logical and physical blocks on its HBA. In-band enjoys the advantage of being able to be integrated into the storage network and serviced in a straightforward way. Since in-band operates in the data path, data security can be beefed up at low cost by means of a storage firewall in the SAN appliance. Out-band is designed in a more complex way because of the interactions between the additional agents on the application servers and the SAN appliance. Unlike in-band this method occupies only a few ports at the switch, so that primarily a greater degree of scalability is available with large redundantly designed SANs. What's more, a SAN appliance failure does not hinder data access. When in-band appliances are in use, all read/write operations on the computer systems connected to the in-band appliances must first be accepted by one of the in-band appliances before they can be forwarded to the storage systems. The functionality for management and distribution of the data can at the same time be integrated both into the computer systems, into the routers, as well as also into the in-band appliance. In the further course it is assumed that the computer systems connected to a storage network or a distributed file server have all the information necessary for the retrieval of data.

A web cache is a unit on a network that, representing one or more web servers, responds to requests from web clients. In order to make the functionality available, the web cache has a storage system on which parts of the web server contents are stored. If the web cache does not store information requested by a client, then the request is forwarded to a supervisory web cache, or the original web server, and responded to by latter. Web caches enjoy a wide distribution on the Internet for various reasons. By means of the use of a web cache, the latent time that transpires between the placing of a request by the web client until the successful delivery of the information to the web client can be significantly reduced. This holds particularly true if the band width between the web cache and the web client is greater than the band width between the web server and the web client or if the web server's load is so great that jams occur when delivering the data on the web server itself. Furthermore, using web caches can reduce the data traffic on the Internet, whereby an increase in the overall performance of the Internet system can be achieved.

Through the cooperation of many web caches that are placed at various locations on the Internet, the performance of the Internet can be clearly enhanced. Examples of the cooperative collaborate of multiple web caches are the NLANR (National Laboratory of Applied Network Research) Caching System that consists of a number of backbone caches in the USA, or the Akamai Caching System that provides caching services for companies throughout the world.

The main difference in the preparation of data retrieval methods on storage networks or distributed file servers and for web caches lies in the fact that in the case of storage networks, the connected computer systems have available all the information regarding the placement strategy that is necessary for retrieving the data utilized by them. This includes, among other things, the number and the properties of the servers connected, with respect to the data storage system. In the case of web caches, the client has available only a limited view of the overall system, i.e. he does not know all the web caches connected to the system. If not all the data are stored on all web caches, this can lead to the web client requesting a piece of information not from a web cache, but rather directly from the web server, because he either does not know any web cache that stores the information requested by him, or because he does know the web cache relevant for him, however, he cannot identify this web cache as responsible for this piece of information.

In order to insure a high efficiency, scalability and robustness of a data storage system, or a web cache, a number of requirements must be fulfilled. A suitable data administration strategy should:
1. be able to fulfill each proportional breakup of the data block onto the storage systems. For identical systems, as a rule, uniform distribution of the data blocks over the systems is required.
2. enable the ability to distribute the data requests pursuant to the proportional allocation of the data blocks to the data storage systems. For the case of various access frequencies of data blocks, this point is not automatically assured by means of point 1.
3. be error tolerant, i.e. be able to withstand data storage failures without loss of data. The lost parts should be able to be generated again in the shortest time possible.
4. assure that with an addition or removal of data storage systems, only the fewest possible number of data blocks must be replaced in order to restore the above points. This should occur to the greatest extent possible without adverse effects to the running operation.
5. assure a compact storage and efficient calculability of placement.

If the client has only incomplete information available on the distribution of the data over the data storage systems, as, e.g., the web caches client, then in addition, the following point must be supported:
6. even if the client only has available incomplete or incorrect information on the structure of the storage system, the data placement strategy must assure that a greatest possible number of accesses to the storage system are successful, i.e., are taken to the server storing the information.

Essentially there are two standard strategies for the storage of data in hard drive systems:
1. the use of an indicator structure that works similarly to the link structure in file systems for classical storage media (as, e.g., hard drives and diskettes), or
2. the use of a virtual address space that is administered similarly to a virtual address space in data processors.

Below we will confine ourselves to the second point and assume the hard drive system data are administered in the form of a virtual address space of data blocks that are uniform in size. The problem therefore consists in finding a suitable mapping of the virtual address space on the hard drives.

The simplest type of mapping is what is called Disk Striping [CPK95], which is used in many approaches in various granularity [PGK88, TPBG93, BBBM94, BHMM93, HG92, BGMJ94, BGM95]. This method has experienced widespread distribution in hard drive fields (also characterized as RAID arrays [RAID=Redundant Array of Independent Disks]) because many of the optimal placement methods (called: RAID level) are designed on disk striping. With disk striping, the data block of the virtual address space (partial blocks of these data blocks) are coiled in a cyclical way around the hard drives. This strategy has the advantage that is very flexible with regard to a changing number of hard drives. A modification by merely one hard drive can require an almost complete reallocation of the data blocks. For this reason, today's hard drive fields are only poorly scalable. Usually for this reason hard drive systems with very many hard drives are segmented into multiple RAID arrays.

The use of random data placements (by means of pseudo-random functions) has already been regarded by many researchers as a very promising alternative method [AT97, B97, SMB98, K97]. In this technology, the data blocks are allocated randomly selected hard drives. Among the first to have tested random data placement strategies are Mehlhorn and Vishkin [MV83]. In particular they tested to what extent multiple randomly placed copies per data block can help in distributing requests uniformly over the storage units. Additional significant results along these lines have been achieved, e.g., by Upfal and Wigderson [UW87] and Karp, Luby and Meyer auf der Heide [KLM92].

Birk [B97] has recommended similar data mapping and access strategies, but he utilized a parity coding of the data blocks.

Further works have been carried out among others by Santos and Muntz as part of the RIO Data Server Project (RIO=Remote I/O) [SMB98, SM98]. They compare the random placement with traditional striping methods and show that even in situations for which disk striping was developed (regular access sample) the random placement is equal in value or better [SM98b]. Their random placement is based on a random sample of a fixed size. If the number of data blocks exceeds this size then they apply the sample once again in order to remap the entire data space on the hard drives. That can naturally lead to unpleasant correlations between the data blocks and cause a deviation from the uniform distribution of the data blocks and requests.

So far, however, there are few approaches that are capable of fulfilling the requirements of an efficient pseudo-randomized data placement. In particular difficulties result if heterogeneous, that means varyingly large, data storage systems are utilized or if data storage systems are dynamically pasted into a system or removed from the system.

An initial approach in order to distribute data blocks dynamically and in a randomized way over data storage systems has been presented in [KLL+97]. There (pseudo-)random functions are used in order to allocate random reel points in the interval [0,1] to the data blocks and data storage systems. A data block is always stored by the data storage system, whose point lies closest to the point of the data block in the [0, 1]-interval. The advantage of this strategy lies in the fact that it is simple to administer and it only requires the replacement of a minimal number of blocks as expected with a changing number of data storage systems. It has, however, the disadvantage that relatively great fluctuations can arise around the expected value for the number of blocks to be stored on a data storage system and the blocks to be replaced and that it is only efficiently applicable for homogeneous data storage systems.

In [BBS99] a method was presented that is also designed on (pseudo-)random functions. The data blocks are mapped on random points in the [0, 1]-interval as also in [KLL+97] by means of such a function. But the allocation of the [0, 1]-interval onto the data storage systems occurs by means of a fixed preset mapping that is called the assimilation function. This function sees to it that each hard drive gets the same portion of the [0, 1]-interval allocated to it. In this way it can be assured that not only the virtual address space data blocks used, but rather also requests can be uniformly distributed over the hard drive. An advantage of this method in comparison to [KLL+98] lies in the fact that the assimilation function can distribute the data over the data storage systems with considerably fewer deviations from uniform distribution. Like the strategy in [KLL+98], this strategy only needs the replacement of a minimal number of blocks as expected with a changing number of data storage systems. However, it only functions well as the strategy in [KLL+98] for homogeneous systems.

Since for reasons of cost it is often not efficient that a storage system consists purely of identical data storage systems, in [BSS00] strategies for non-uniform data storage systems were also designed. These are based on the strategy presented in [BBS99] for identical data storage systems. At first it is assumed that all systems have the same storage capacity. For the interval parts that extend beyond the capacity of a data storage system, then in a second round once again the strategy for identical hard drives is applied, however, this time only for the data storage systems that still have free capacities after the first placement round. The interval parts that cannot be accommodated at that time are placed once again in an additional round, etc., until the complete [0, 1]-interval is accommodated. The main disadvantage of this method lies in the fact that there are situations in which obviously more data are replaced that the minimal amount necessary.

The problem that should be solved by the invention consists in preparing a method and an arrangement for randomly storing data on storage networks and/or an intranet and/or the Internet as well as a corresponding computer program product and a corresponding computer readable-storage medium, by means of which the above-mentioned disadvantages can be eliminated and particularly there can be guaranteed an effective treatment of storage networks that include heterogeneous storage mediums, as well as a dynamic scaling of storage networks by means of pasting or removal of storage mediums.

This problem is resolved inventively by means of the characteristics in the referenced part of the claims 1, 15, 23 and 24 in conjunction with the characteristics in the characterizing clause. Appropriate designs of the invention are contained in the subclaims.

A particular advantage of the invention lies in the fact that by means of the method for randomly storing data on data storage networks and/or an Internet and/or the Internet, the treatment of changes on the storage network will be quite considerably simplified by a number of data blocks Dᵢ(i=1, . . . , m) being allocated to an number of data storage systems Sⱼ(j=1, . . . , n) in accordance with the following steps and being stored there:
a) a virtual storage space will be allocated to the total amount of data storage systems and by an initial random process, at least a partial space Iⱼ of the virtual storage space to each individual data storage system Sⱼ(j=1, . . . , n), whereby the ratio between the partial space Iⱼ and the overall virtual storage space at least approximately corresponds to the ratio of values of a preset parameter relating to the data storage system Sⱼ or to the overall amount of the data storage systems,
b) a (random) element h(i) of the virtual storage space is allocated by a second random process to each data block Dᵢ(i=1, . . . , m),
c) for each data block Dᵢ (i=1, . . . , m) at least one partial space Iₖ is determined, in which h(i) is contained and the data block Dᵢ is allocated to at least one data storage system Sₖ represented by this/these partial space(s) Iₖ and stored there.

An arrangement for randomly storing data on storage networks and/or and intranet and/or the Internet is advantageously set up in such a way that it includes at least one processor that in turn is set up so that a method for randomly storing data on storage networks and/or an intranet and/or the Internet can be carried out, whereby the randomized data storage contains the method steps in accordance with one of the claims 1 to 14.

A computer program product for randonmly storing data on storage networks and/or an intranet and/or the Internet includes a computer-readable storage medium, on which a program is stored that enables the computer, once it has been loaded into the computer's memory, to carry out a method for randomly storing data on storage networks and/or an intranet and/or the Internet, whereby the randomized storage of data includes method steps in accordance with one of the claims 1 to 14.

In order to carry out randomized data storage on storage networks and/or an intranet and/or the Internet, a computer-readable storage medium will be advantageously used, on which a program is stored that enables the computer, once it has been loaded into the computer's memory, to carry out a method for randomly storing data on storage networks and/or an intranet and/or the Internet, whereby the randomized data storage includes the method steps in accordance with one of the claims 1 to 14.

In a preferred embodiment of the inventive method it is planned that with the first and/or second random process pseudo-random functions will be applied.
There proves to be a further advantage if data storage networks Sⱼ whose value Cⱼ of the presettable parameter exceeds the also presettable second value δ in

$$⌊ \frac{{c}_{j}}{δ} ⌋$$

new virtual data storage systems Sⱼ with cⱼ=δ and—if

$${c}_{j} - ⌊ \frac{{c}_{j}}{δ} ⌋ * δ \neq 0$$

into another virtual data storage system Sₖ with

$${C}_{k} = {C}_{j} - ⌊ \frac{{c}_{j}}{δ} ⌋ * δ$$

are fragmented and in each case by the first random process at least a partial space Iⱼ or Iₖ of the virtual storage space is allocated to these virtual data storage systems, whereby └a┘ describes an integral portion of the number aε3.

Furthermore, it is advantageous if the virtual storage space is represented by the interval [0, 1] and the partial spaces Iⱼ by at least one partial interval contained in [0, 1] and in the first random process the left edge of the interval Iⱼ is determined by the application of an initial hash function g(j) and the length of the interval calculated pursuant to (g(j)+s*cⱼ) with:

cⱼ: value of the parameter relating to the data storage system Sⱼ and

s: stretch factor that is chosen in a way that s*cⱼ<1 is fulfilled.

At the same time it is advantageous if the stretch factor s is chosen in such a way that the interval [0, 1] is completely covered by the partial intervals Iⱼ.

In the second random process, advantageously by means of the application of a second hash function h(i), each data block Dᵢ(I=1, . . . , m) is allocated a number h(i)ε[0, 1).

In a preferred embodiment of the method for randomly storing data, it is planned that the presettable parameter describes the physical capacity of data storage systems or the request load of data storage systems or correct deviations from the desired distribution.

In such a case that the element h(i) allocated to a data block Dᵢ is contained in multiple partial spaces Iⱼ it proves to be advantageous that a uniform placement strategy be applied in order to allocate the data block Dᵢ to a data storage system represented by the partial spaces Iⱼ.

Furthermore, it is advantageous that with changes to at least one of the values C=(c₁, . . . , cₙ) of the presettable parameter, another allocation of the data blocks Dᵢ to the data storage systems Sⱼ be effected according to the method for randomly storing data pursuant to one of the claims 1 to 9 setting the new parameter values C′=(c₁′, . . . , cₙ′) as the basis.

In certain instances it can be useful with only small changes to values of the presettable parameter to perform no reallocation of the data blocks. This is achieved with changes to at least one of the values C=(c₁ . . . , cₙ) of the presettable by a new allocation of the data blocks Dᵢ to the data storage systems Sⱼ only being effected according to the method for randomly storing data pursuant to one of the claims 1 to 9 setting the new parameter values C′=(c_{1′}, . . . , c_{n′}) as the basis if a new parameter value cᵢ varies from the corresponding current parameter value cᵢ by a presettable value μ.

With big changes to the presettable parameter again, it is advantageous that adaptations of the system be performed with changes of at least one of the values C=(c₁, . . . , cₙ) into a new parameter value C′=(c_{1′}, . . . , c_{n′}) in stages by another allocation of the data blocks Dᵢ to the data storage systems Sⱼ being effected according to the method for randomly storing data pursuant to one of the claims 1 to 9, whereby at each stage k intermediate parameter values C^{k}=(c^{k}₁, . . . , c^{k}ₙ) with |c₁−c^{k}₁|#/cᵢ+c′ᵢ/(i=1, . . . , n) are set as the basis. This procedure has the great advantage that the system in contrast to a direct update can respond substantially quicker to high request loads or a new capacity distribution C″ chosen by the administrator because in each Cⁱ the transition process from C to C′ can be broken off.

Furthermore, it is also an advantage that for storing the data blocks in a storage medium at least one table can be prepared in which the allocation between virtual address and physical address is stored on the storage medium.

A further advantage of the inventive method for randomly storing data consists in the fact to an extent there is a merging of multiple data blocks to which in the table a common physical address on the storage medium is allocated, whereby the data blocks of an extent in logical address space are linked with each other by the first data block of an extent that consists of 2^{λ} obtaining an address in the form x00 . . . 000, whereby the lower λ bits are zero, the last block of this extent gets the address x11 . . . 111, whereby the lowest λ bits are 1 and the physical position of a data block is derived by addition of the table entry for the pertinent extent to the last λ bits of the data block's logical address. By means of this procedure, the number of table entries to be backed up is reduced.

In a preferred embodiment of the invention it is planned that the arrangement includes at least one data storage system and/or at least one computer system that accesses the storage medium in a read and/or write mode and/or at least one control unit switched in between the computer system(s) and the data storage system(s) for control of the method for randomly storing data. The data storage systems encompass at the same time beneficial hard drive storage fields and/or intermediate designed web caches.

Further it turns out to be beneficial if the arrangement comprises one control unit switched between the computer system(s) and the data storage system(s). At the same time it can prove to be useful that the method for randomly storing data be implemented as RAID hardware method in the controller unit.

In an additional preferred embodiment of the Invention it is planned that the arrangement include at least one dedicated computer system (SAN appliance) linked via means for data exchange with storage mediums and computer systems of the arrangement to coordinate the storing of data and/or search resources (in-band appliances) linked via means for data exchange with storage mediums and computer systems of the arrangement for distributing data blocks.

It also proves to be an advantage that the arrangement includes a heterogeneous storage medium.

Below, the invention should be more closely illustrated using, at least in part, embodiments depicted in figures.

Indicated are:

FIG. 1 Design of a storage network,

FIG. 2 Illustration of the out of band virtualization of the data space,

FIG. 3 Illustration of the in-band virtualization,

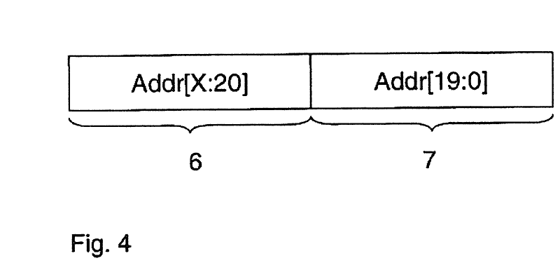

FIG. 4 Partitioning of the virtual address of a data block for determining the pertinent hard drive and the pertinent metablock.

As is apparent from the profile of requirements of the data administrator strategy, the solution of the problem in general is dependent on whether the clients 3 connected to a system have available all the information necessary for the distribution of data. Below, the inventive method, which subsequently is characterized as share strategy, is presented which is capable of guaranteeing in both cases almost optimal distributing and access properties.

Afterwards, in short, requirements and definitions will be presented that will be used with the description of the embodiment.

The number of data blocks to be stored on a system is characterized by m, the number of maximum usable data storage systems by N. N here will be preset by means of the data placement strategy and is not dependent on the current number and size of the data storage systems. The number of the data storage systems actually available on the system will be characterized by n. For the case that the number the data blocks storable by the data storage systems is smaller than m, it is necessary that an additional storage system be made available onto which data blocks that are currently unmappable can be swapped out.

The share of data blocks that can be stored by one data storage system i is characterized as the relative capacity cᵢ∈[0, 1), whereby Σᵢ cᵢ=1. The size of the individual c₁ here can depend on various factors, such as, e.g., on the storage capacity if it is a matter of a hard drive or on the band width of the connected links with a web cache. The goal of a data placement strategy should be that on each “i” at m data blocks to be placed cᵢ*m data blocks are stored. With the description of the technologies to be implemented it is not assumed that the number of data storage systems on the system changes. This situation can be modeled by the relative capacity cᵢ of a data storage system i that is not located on the system at the moment t, at this moment is set to zero.

The task of the data distributing strategy can now be broken down into two task points. In the first step a data block with its virtual address must be allocated to a data storage system. This allocation will be characterized below as global data distribution. In a second step a data block must not only be allocated to a data storage system, but also in addition to a position on this data storage system. This allocation below will also be characterized as local data distribution. The invention deals with the problem of global data distribution. As part of the description of the inventive method, briefly simple local data distribution strategies are presented that enhance our new global data distribution strategies.

A requirement for the use of the share strategy is that it, as a subroutine, can be used by a function that solves the problem of data distribution for uniform data storage systems, i.e., for the case that cᵢ=1/n for all i. Possible strategies for the uniform case have been presented in [KLL+97] and [BBS00].

The share strategy will be described now in detail: In share each storage system one or more intervals is allocated, the overall size of which corresponds to the relative system capacity. These intervals are mapped onto a [0, 1)-interval but in contrast to earlier strategies, may overlap with other intervals. Each data block is now allotted a real point in the [0, 1)-interval by means of a (pseudo-)random function. This point can possibly be part of multiple intervals of storage systems. If that is the case a uniform placement strategy is utilized in order to allocate the data block to one of these storage systems. Should the relative capacities of the storage systems change now, the interval lengths will be adjusted accordingly.

Below we are first going to give a detailed description of the share strategy and subsequently explain why it is superior to other strategies.

The strategy for uniform data storage systems used by the share strategy will be characterized below as uniform (b,S), whereby b describes the virtual address of the data block and S the quantity of data storage systems. The return of the function is provided by the data storage system onto which the data block b has been placed.

The share strategy is based on two additional hash functions that, aside from the hash functions possibly used for the uniform strategy, must be prepared. The hash function h: {, . . . , M}→[0,1) distributes the data blocks pseudo-randomly over the interval [0,1). A further hash function g: {1, . . . , N}→[0,1) assigns to the data storage systems involved a point in the interval [0,1). Furthermore, the parameters s, δε[1/N,1] are used, the significance of which will be explained later during the course of this document.

It is assumed that n data storage systems are given with (c₁, . . . , cₙ)ε[0,1)ⁿ. Then the following strategy is used: for each data storage system with

$${c}_{i} \geq δ , ⌊ \frac{{c}_{i}}{δ} ⌋$$

new virtual data storage systems I′ with cᵢ,=δ are pasted. If the sum of the relative virtual data storage system capacities does not match the original capacity, an additional virtual data storage system j with

$${c}_{j} = {c}_{i} - ⌊ \frac{{c}_{i}}{δ} ⌋ * δ$$

is pasted. Data storage systems whose demand is lower than δ are left in their original form and regarded as individual virtual data storage systems. A maximum of n′≧n+1/δ virtual data storage systems are created by means of the transformation of the data storage systems.

Now an interval Iᵢ of length s*cᵢ that stretches from g(i) to (g(i)+s*cᵢ)mod1 is allocated to each virtual data storage system “i.” The [0, 1) area is thus regarded as a ring around which the individual intervals are wrapped. The constant s is characterized as a stretch factor. In order to keep an individual interval from being wrapped around the ring numerous times δ≦1/s should be chosen. Aδ≧1/s is possible, however it complicates the implementation of the method.

For each xε(0, 1) let cₓ={i: xεIᵢ), the quantity of intervals in which x is contained. The number of the elements c_{x=|}c_{x|} in this quantity is characterized as contention. Because the number of end points of the intervals of the virtual data storage systems amounts to a maximum of 2n′≦2(n+1/δ) the [0, 1) interval is segmented into at most 2 (n+1/δ) frame Fⱼε(0,1) in a way that for each frame Fⱼ the quantity cₓ identical for each xεFⱼ. The limitation of the number of frames is important in order to limit the size of the data structures for share strategy.

Calculation of the data storage system belonging to a data block is carried out now by means of call up: uniform (b, C_{h(b)}).

A significant advantage of the invention lies as mentioned in the fact that it allows for the treatment of changes on the storage network 1 in an extremely simple way. Depending on demand it may at the same time prove to be reasonable to respond to changing surroundings by an adaptation of the share strategy.

So far there was an explanation of how the placement of data blocks is performed on a static system. Now the assumption is that distribution of the relative capacity on the system changes from C=(c₁, . . . , cₙ) to C′=(c_{1′}, . . . c_{n′}). As explained above this also covers the case that new data storage systems arrive on the system or data storage systems leave the system. Now there are various conceivable versions to undertake a transition from C to C′.

Variation 1: Direct Update

The simplest method lies in transitioning directly from C to C′ and performing the corresponding replacements. That has the disadvantage that even with the smallest modifications due to the use of pseudo-random functions replacements of multiple data blocks possibly must be performed and with great modifications the system is located in a transitional condition for a long time, which can jeopardize the maintenance of operation of the above-mentioned fourth point of the requirements for data administration strategies.

Variation 2: Lazy Update

Below, a strategy is presented that sees to it that with very low capacity modifications no data are to be redistributed.

Let 0<μ<1 a fixed constant that is characterized as laziness of the share strategy. The share strategy alters the relative capacity of a data storage system i from cᵢ to cᵢ′, only if cᵢ′≧₍1+μ) cᵢ or cᵢ′≦(1−μ) cᵢ. Hereby the sum of the relative capacities deviate from 1 over all data storage systems, yet remains in the area of 1±μ so that with a small μ the properties of share strategy are not jeopardized.

Variation 3: Smooth Update

This variation is recommendable for the case of greater capacity variations. If C and C′ have great deviations in capacity at first, intermediate stages C₁, C₂, C₃, . . . , Cₜ are calculated so that with C=C₀ and C′=Cₜ₊₁ for each i in (0, . . . ,t) Cᵢ and Cᵢ₊₁ lie closely enough together that it is possible for the system to transition fast from the one capacity distribution to the other and thus into a stable condition. This process has the great advantage that the system, in contrast to direct update, can respond substantially faster to high request loads or a capacity distribution C″ newly selected by the administrator because in each Cᵢ the transition process from C to C′ can be broken off.

Specific implementations of the methods are explained in the additional description.

Choice of the Capacities:

The choice of capacities for share must not necessarily be directed at the physical capacity of the storage system. Because share permits any capacity distributions at all, the share capacity can also be used in order to perform a better balancing of the request load in order, for example, to eliminate bottlenecks in the links to storage systems or in the storage systems themselves. Furthermore, they can be used in order compensate for deviations from the desired distribution (that due to use of pseudo-random hashing functions cannot be ruled out). The share strategy therefore allows for high flexibility in the distribution of data and a high robustness, and thus fulfills important requirements for a storage system.

Below several more special aspects of the inventive method are explained:

1. Coverage of the [0,1) Interval

To be able to insure that the share strategy can assign to each data point a data storage system, the [0,1) interval must be completely covered by the virtual data storage systems' intervals. This can already be assured with the hash function g after distribution of the data storage systems' intervals by getting the coverage checked and if need be shifting individual intervals. With a random placing of the intervals by means of a pseudo-random hash function h, it is sufficient to use a stretch factor s=k*ln n with k≧3 so that with higher probability the data storage intervals cover the [0, 1) interval. High probability here means that the probability that an area is not covered is less than 1/n. If a check of the distribution reveals that not every point of the [0, 1) is covered then the covering can be effected by adapting the stretch factor.

2. Needed Storage Place and Calculation Complexity

If the strategy presented in [KLL+97] is going to be used as a homogeneous data placement strategy uniform (b, S), then the time expected to evaluate the data storage system associated with a data block lies in O(1). The storage complexity for evaluating the share strategy lies in O(s*k*(n+1/δ)). Not included here are the storage and evaluation complexity of the hash functions used.

3. Performance of the Distribution

If pseudo-random hash functions are used and a stretch factor s≧6 ln(N/σ²) with σ=∈/(1+∈) then the portion of the data blocks that are stored on a data storage system i with high probability moves in the area S₁ε[(1−∈)di, (1−∈)dᵢ].

Represented in the following sections is how the design of data storage system can be performed efficiently by means of the share strategy. Indication is given that it is merely a matter of implementation sample. In an initial step, a presentation is made on how the functionality can be integrated into a general RAID system:

Integration of Share Strategy into a General RAID System: by Adapting the Stretch Factor.

The share strategy can be used in order to configure hard drive surfaces on systems that consist of a quantity of storage mediums, of multiple computer systems and a controlling unit. In so doing the share strategy can be integrated both on the linked computer systems and software RAID methods, as well as in the control unit and Hardware RAID method. The share strategy is on this, responsible for the allocation of data blocks over the hard drives; the allocation of the data block to a physical address on the hard drive, is assumed by a strategy underlying the share strategy. An opportunity for the allocation of the physical position resides in mapping in which an allocation between virtual and physical address is stored on the hard drive.

In so doing it is possible to reduce the number of table entries to be backed up by not allocating to each individual data block its own entry, but by disposing of block quantities of a minimal size, hereinafter characterized also as extents, over a common entry in the table. With an extent it is a matter of a quantity of blocks that are interlinked in the logical address space. An extent consists of 2^{λ} blocks. The first block of the extent has an address in the form xx00 . . . 000, whereby the lower λ bits 7 are represented by the number zero. The last block of the extent has the address x11 . . . 111, whereby the lowest λ bits 7 are represented by the numbers one. The physical position of the data block is obtained by the addition of the table entry for the respective extent and the lower λ bits 7 of the logical address of the data block. If each table entry is in the form y00 . . . 000, i.e. the lower λ bits 7 are set at zero, the addition can be performed by a simple disjunction. The upper bits 6 of the virtual address of a data block therefore serve for evaluating the allocated storage medium and the determination of the table entry for the extent, the lower bits 7 serve as offset within the extent. A table entry is allocated to all data blocks that have common upper bit 6. This table entry can, e.g., be stored on the place where the evaluation of the share strategy is also carried out.

Integration of the Share Strategy into a Storage Network 1:

The integration of global data distribution strategies on a storage network 1 proceeds form a structure in accordance with FIG. 1. The overall system consists of a quantity of file and database servers, hereinafter characterized as computer systems, that are connected via a storage network 1 to data storage systems 4. The storage network 1 encompasses further a number of switches or routers 2 that provide the delivery of data among communicating units. The computer systems are to be regarded here in this context as clients 3 that read blocks from the data storage systems 4, or write data blocks to the data storage systems 4. With the aid of the share strategy any partial quantity at all M of the storage systems 4 connected to the storage network 1 can be administered as a single logical storage pool that has a linear address space available The quantity of storage systems 4 can at the same time be fragmented into multiple smaller or into a large storage pool, whereby none of the storage systems 4 should be allocated to more than one storage pool. Hereinafter, only the case that the system consists of one storage pool is considered.

From a storage pool multiple virtual storage systems can be set up, whereby each of these virtual storage systems is administered pursuant to the share strategy, if a storage pool consists of a partial quantity M of the storage systems, thus call up of the share strategy is effected for the logical storage systems pursuant to the overall partial quantity M. A storage policy covering the features as well as the physical block size and redundancy is assigned to each virtual storage system. This allocation can be carried out separately for each virtual storage system or once for the whole storage pool. After data has been written to a virtual hard drive, the storage policy in general cannot be changed any longer.

If a computer system accesses an extent that heretofore has not been used by the computer system and for which no table entry exists on the computer system, a new table entry must be allocated. The allocation can be carried out in two Ways:
1. From a central authority that has general knowledge about all table entries, the computer system requests a table entry application for the extent,
2. On each storage system 4 an area is reserved that performs an allocation between virtual address and physical address. The computer system first looks for the virtual address of the extent. If this address is not yet reserved, the computer system searches for an address on the storage system 4 that is still free

If the coordination is not performed by a central authority, then this task must be assumed according to FIG. 1 by one or more on-line computer systems. Moreover, however, also one or more dedicated devices that are designated as SAN appliances 5 can be connected to the storage network 1 for coordination of computer systems pursuant to FIG. 2. Aside from relieving the computer system by coordination, the use of SAN appliances 5 can insure that all on-line computer systems have the same view of the storage systems 4, i.e., be informed at the same time about leaving or joining storage systems 4.

The SAN appliance 5 thus offers a number of interfaces over which information can be exchanged between the SAN appliances 5 and the client processors 3. These include:
Query of the basic set up of each client 3,
Query as to the extents of each client 3,
Clients' 3 information on changes to the infrastructure.

The share procedure can also be integrated into so-called in-band appliances (see FIG. 3). With the in-band appliances it is a matter of dedicated systems that perform a transformation of the logical data block address that they receive from the on-line computer systems into the physical address. The use of in-band appliance is necessary if the functionality of the share strategy cannot be integrated directly into the computer systems because no version of the share strategy software is available for these computer systems or the performance of the on-line computer systems is not sufficiently large enough in order to carry out the transformation of the logical address into the physical addresses.

An in-band appliance from the standpoint of the storage systems 4 behaves like an on-line computer system, from the standpoint of computer system connected to the in-band appliance like a physical storage system.

On the storage network 1 in-band appliances can be mixed with computer systems on which the share strategy is loaded.

Setup of Internet Systems with Assistance of Share Strategy:

The problem with the setup of systems for delivery of data objects over the Internet differs from the setup of storage systems to the extent that clients 3 on the Internet have no global view over all available web servers and web caches on the system. Should a piece of information from a web cache be read in order to relieve the participating web server it must be insured that the client 3 at least knows the web cache is part of a data object and can also allocate the data object to be read to the right web cache.

The problem in general cannot be resolved without filing numerous copies of a data object that pursuant to a preset placement strategy are distributed via the web caches. If k copies of one data object are stored by a system, then the client 3 inquires one after the other or simultaneously at the k web caches from which he believes that they have a copy of the data object. If one of the web caches holds a copy of the data object then this copy will subsequently be read by client 3.

The number of necessary copies so that a client 3 at least allocates one web cache to a data object that also stores this data object is dependent on the distribution strategy used and the relative capacities C=(c₁, . . . cₙ) of the web caches. Furthermore, if it is dependent on the view V=(v₁, . . . , vₙ) of the client 3; that means on the relative sizes of web caches that the client believes he knows. The consistency kᵥ of a client 3 is defined as follows:

$${K}_{V} = {\sum }_{i = 1}^{n} min [ {v}_{i} , {c}_{i} ]$$

It can be shown that with use of share strategy, the use of Θ(log N) copies is sufficient in order to guarantee with a probability of greater than

$$( 1 - \frac{1}{n} )$$

that at least for the data object of the web cache that is evaluated by the share strategy for C and V is the same.

The invention is not limited to the embodiments presented here. Moreover, it is possible by combination and modification of the designated means and features to realize further design variations and leave without the framework of the invention.

### LIST OF REFERENCE CHARACTERS

1 Storage Network
2 Switches or Routers
3 Client
4 Data Storage System
5 SAN Appliance
6 Upper Bits
7 Lower Bits

### REFERENCES

[AT97] J. Alemany and J. S. Thatachar, “Random Striping News on Demand Server,” Technical University of Washington Report, Department of Computer Science and Engineering. 1997
[B97] Y. Birk, “Random RAIDs with Selective Exploitation of Redundancy for High Performance Video Servers,” In Proceedings of 7^{th} International Workshop on Network and Operating System Support for Digital Ausio [sic] and Video, 1997
[BBBM94] M. Blaum, J. Brady, J. Bruck and J. Menon, EVENODD: An Optimal Scheme for Tolerating Double Disk Failures in RAID Architectures,” In Proceedings of the 21^{st} Annual International Symposium on Computer Architecture, pages 245-254, 1994
[BBS99] P. Berenbrink, A. Brinkmann and C. Scheideler, “Design of the PRESTO Multimedia Data Storage Network,” In Proceedings of the Workshop on Communication and Data Management in Large Networks (INFORMATIK 99), 1999
[BGM95] S. Berson, L. Golubchik and R. R. Muntz, “Fault Tolerant Design of Multimedia Servers”. In SIGMOD Record (ACM Special Interest Group on Management of Data), 19(2):364-375, 1995 [BGMJ94] S. Berson, S. Ghandebarizadeh, R. R. Muntz and x. Ju, “Staggered Striping in Multimedia Systems,” 1994 ACM In Proceedings of the Conference on Management of Data (SIGMOD), pages 79-90. 1994
[BHMM93] M. Blaum, H. T. Hao, R. L. Mattsoll and J. M. Menon. “Method and Means for Encoding and Rebuilding Data Contents of up to two unavailable DSDS in an in an Array of DASDs,” U.S. Pat. No. 5,271,012, December, 1993
[BSS00] A. Brinkmann, K. Salzwedel and C Scheideler: “Efficient. Distributed Data Placement for Storage Area Networks,” In Proceedings of the 12^{th} Symposium on Parallel Algorithms and Architectures (SPAA 2000), 2000
[CPK95] A. L. Chervenak, D. A. Pattersoll and R. H. Katz, “Choosing the best storage system video service,” In Proceedings of the third ACM International Multimedia Conference and Exhibition, pages 109-120, 1996
[HG92] M. Holland and G. Gibson, “Parity Declustering for Continuous Operation in Redundant Disk Arrays,” In Proceedings of the Fifth International Conference on Architectural Support for Programming Languages and Operating Systems, pages 23-35, 1992
[K97] J. Korst, “Random Duplicated Assignment: An Alternative to Striping in Video Servers,” In Proceedings of the Fifth ACM International Multimedia Conference, pages 219-226, 1997
[KLL+97] D. Karger, E. Lehman, T. Leighton, M. Levine D. Lewin and R. Panigrahy: “Consistent Hashing and Random Trees: Distributed Caching Protocols for Relieving Hot Spots on the World Wide Web,” In Proceedings of the Twenty-Ninth Annual ACM Symposium on Theory of Computing (STOC), pages 654-663, 1997
[KLM92] R. Karp, M. Luby and F. Meyer auf der Heide. “Efficient PRAM Simulation on a Distributed emory Machine, In Proceedings of the 24^{th} ACM Symposium on Theory of Computing, pp. 318-326, 1992
[MV83] K. Mehlborn and U. Vishkin, “Randomized and deterministic simulation of PRAMs by parallel machines with restricted granularity of parallel memories,” In Proceedings of 9^{th} Workshop on Graph Theoretic Concepts in Computer Science, 1983
[PGK88] D. A. Pattersoll, G. Gibson and R. H. Katz, “A Case for Redundant Arrays of Inexpensive Disks (RAID),” In Proceedings of the 1988 ACM Conference on Management of Data (SIGMOD), pages 109-116, 1988
[SM98] J. R. Santos and R. R. Muntz. “Performance Analysis of the RIO Multimedia Storage System with Heterogeneous Disk Configuration,” In Proceedings of ACM Multimedia 98, pages 303-308, 1998
[SM98b] J. R. Santos and R. R. Muntz, “Comparing Random Data Allocation and Data Striping in Multimedia Servers,” Technical University of California Report, Los Angeles, Computer Science Department, 1998
[SMB98] J. R. Santos, R. R. Muntz and S. Berson, “A parallel Disk Storage System for Realtime Multimedia Applications,” International Journal of Intelligent Systems, 13(12): 1137-1174, 1998
[TPBG93] F. A. Tobagi, J. Pang, R. Baird and M. Gang, “Streaming RAID: A Disk Array Management System for Video Files,” In Proceedings of Computer Graphics (Multimedia '93 Proceedings), pages 393-400, 1993
[UW87] E. Upfal and A. Wigderson, “How to Share Memory in a Distributed System,” Journal of the ACM, 34(1): 116-127, 1987

1. A method for randomly storing data on at least one of the group consisting of data storage networks, an intranet, and an Internet, characterized in that a quantity of data blocks Dᵢ(i=1, . . . , m) is allocated to a quantity of data storage systems Sⱼ (j=1, . . . , n) pursuant to the following steps and stored there:
a) allocating a virtual storage space to an overall quantity of data storage systems and at least one partial space Iⱼ of the virtual storage space to each individual data storage system Sⱼ (j=1, . . . , n) by an initial random process, whereby the relationship between the partial space Iⱼ and the overall virtual storage space at least approximately matches the relationship of the values of a presettable parameter relating to the data storage system Sⱼ or the overall quantity of data storage systems,
b) allocating a (random) element h(i) of the virtual storage space to each data block Dᵢ (i=1, . . . , m) by means of a second random process,
c) determining for each data block Dᵢ (i=1, . . . , m) at least one partial space Iₖ containing h(i) and allocating the data block Dᵢ to at least one of the data storage systems Sₖ represented by this (these) partial data space(s) Iₖ and stored there.

2. The method according to claim 1, characterized in that with at least one of an initial random process and a second random process, pseudo-random functions are applied.

3. The method according to claim 1, characterized in that wherein said data storage systems Sⱼ has a value cⱼ of the presettable parameter that exceeds a second value δ that is also presettable, is fragmented into
$$⌊ \frac{{c}_{j}}{δ} ⌋$$
new virtual data storage systems Sⱼ, wherien cⱼ=δ and wherein when
$${c}_{j} , = ⌊ \frac{{c}_{j}}{δ} ⌋ * δ \neq 0.$$
is fragmented into another virtual data storage system Sₖ wherein
$${c}_{k} = {c}_{j} - ⌊ \frac{{c}_{j}}{δ} ⌋ * δ$$
and in each case at least one partial space Iⱼ, or Iₖ of the virtual storage space is allocated to the virtual data storage systems by means of a random process, whereby └a┘ describes the integral part of a number aε3.

4. The method according to claim 1, characterized in that the virtual storage space is represented by the interval [0, 1) and the partial spaces Iⱼ by at least one partial interval contained in [0, 1).

5. The method according to claim 1, characterized in that in the initial random process the left edge of the interval Iⱼ is determined by the application of an initial hash function and the length of the interval is calculated in accordance with (g)(j)+s*cⱼ) wherein:
cⱼ equals a value of the parameter relating to the data storage system and
s equals a stretch factor, selected in such a way that s*cⱼ<1 is fulfilled.

6. The method according to claim 1, characterized in that the stretch factor s is selected in a manner that the interval [0, 1) is completely covered over by the partial intervals Iⱼ.

7. The method according to claim 1, characterized in that in the second random process a number h(i)ε[0, 1) is allocated to each data block Dᵢ (I=i, . . . , m) by means of an application of a second hash function h(i).

8. The method according to claim 1, characterized in that the presettable parameter is selected from the group consisting of:
a physical capacity of data storage systems,
a request load of data storage systems and
correct deviations from the desired distribution.

9. The method according to claim 1, characterized in that when the element h(i) is allocated to a data block Dᵢ contained in multiple partial spaces Iⱼ a uniform placement strategy is applied in order to allocate the data block Dᵢ to one of the data storage spaces represented by the partial spaces Iⱼ.

10. The method according to claim 1, characterized in that when a change occurs in at least one of the values C=(c₁, . . . , cₙ) of the presettable parameter, a repeated allocation of the data blocks Sⱼ be carried out in accordance with the method of claim 1 while setting the new parameter values C′=(c_{1′}, . . . c_{n′}) as the basis.

11. The method according to claim 1, characterized in that when a change occurs in at least one of the values C=(c₁, . . . cₙ) of the presettable parameter, a repeated allocation of the data blocks Dᵢ to the data storage systems Sⱼ is carried out according to the method of the claim 1 while setting new parameter values C′=(c_{1′}, . . . c_{n′}) as the basis if a new parameter value cᵢ varies from the corresponding current parameter value c₁, by a presettable constant μ.

12. The method according to claim 1, characterized in that with changes in at least one of the values C=(c₁, . . . cₙ) of the presettable parameter into a new parameter value C′=(c_{1′}, . . . c_{n′}) a repeated allocation of the data blocks Dᵢ to the data storage spaces is carried out in stages Sⱼ according to the method of claim 1, whereby at each stage k intermediate parameter values C^{k}=(c^{k}₁, . . . c^{k}ₙ) with |cᵢ−c^{k}ᵢ|#|cᵢ−c′ᵢ|(i=1, . . . , n) are set as the basis.

13. The method according to claim 1, characterized in that when storing data blocks in a storage medium at least one table is prepared in which the allocation between virtual address and physical address on the storage medium is stored.

14. The method according to claim 13, characterized in that multiple data blocks are summarized in an extent to which is allocated in the table a common physical address on the storage medium, wherein data blocks of an extent are linked with each other in a logical address space by a first data block of an extent that consists of 2^{λ} obtaining an address in the form x00 . . . 000, whereby lower λ bits are represented by the number zero, the last block of the extent receives an address x11 . . . 111, whereby the lowest λ bits are represented by means of the number one, and a physical position of a data block is derived adding up of table entries for said extent to λ bits of said logical address of the data block.

15. An arrangement with at least one processor that is equipped in such a manner that a method for randomly storing data on at least one of the group consisting of storage networks, an intranet and an Internet is executable, whereby the randomized storage of data includes the steps of the method of claim 1.

16. The arrangement according to claim 15 characterized in that the arrangement includes at least one of the items selected from the group consisting of
a data storage medium,
a computer system that accesses by reading and/or by writing to
a storage media, and
a controller unit switched in between a computer system and the method for randomly storing data.

17. The arrangement according to claim 16, characterized in that the data storage system includes at least on the group consisting of
hard drive surfaces and
intermediate storage spaces used as web caches.

18. The arrangement according to claim 15, characterized in that the arrangement includes at least one controller unit switched in between a computer system and a data storage system for controlling a method of randomly storing data.

19. The arrangement according to claim 18, characterized in that the arrangement includes a computer system that accesses a storage media via a controller unit.

20. The arrangement according to claim 15, characterized in that the method for randomly storing data is implemented as a hardware RAID method in a controller unit.

21. The arrangement according to claim 15, characterized in that the arrangement includes
at least one dedicated computer system that is linked via data exchange means with storage media and computer systems for coordinating storing of data and/or processor resources linked via means for data exchange with storage media and computer systems for distribution of data blocks.

22. The arrangement according to claim 15, characterized in that the arrangement includes heterogeneous storage media.

23. A computer program product that includes a computer-readable storage medium on which is stored a program that enables a computer, once it has been loaded into the memory of the computer, to perform a method for randomly storing data on at least one the group consisting of data networks, an intranet and an Internet, whereby the randomized data storage includes the method to of claim 1.

24. A computer-readable storage medium, on which a program is stored that enables a computer, after it has been loaded into the memory of the computer, to perform a method for randomly storing data on at least one of the group consisting of storage networks, an intranet and an Internet, whereby the randomized data storage includes the method of claim 1.
